(19) United States
(12) Patent Application Publication
(10) Pub. No.: US 2021/0098844 A1
(43) Pub. Date: Apr. 1, 2021

(54) HOUSING FOR RECEIVING BATTERY CELLS, AND METHOD FOR PRODUCING THE SAME

(71) Applicant: WEBASTO SE, Stockdorf (DE)

(72) Inventors: Jochen HAUSSMANN, Stockdorf (DE); Michael SCHÖNBERGER, Stockdorf (DE); Jan WOKÖCK, Stockdorf (DE); Hendrik POMP, Stockdorf (DE)

(21) Appl. No.: 16/955,371

(22) PCT Filed: Dec. 19, 2018
(86) PCT No.: PCT/EP2018/085773

§ 371 Date: Aug. 18, 2020

(30) Foreign Application Priority Data
Dec. 19, 2017 (DE) 10 2017 130 557.2

(51) Int. Cl. H01M 50/204; H01M 50/249; H01M 50/224; H01M 50/30

(52) U.S. Cl. CPC H01M 50/204; H01M 50/249; H01M 2220/20; H01M 50/394; H01M 50/224

(57) ABSTRACT

A housing for receiving battery cells, in particular for forming a battery system for a motor vehicle, includes a first housing part and a second housing part connected to the first housing part. A sealing channel is formed between the first housing part and the second housing part. A sealant for sealing the first housing part against the second housing part is arranged in the sealing channel. A corresponding production method is also described.

### CROSS REFERENCE TO RELATED APPLICATIONS

This application is a national stage of International Application No. PCT/EP2018/085773, filed Dec. 19, 2018, which claims priority from German Patent Application No. 10 2017 130 557.2 filed on Dec. 19, 2017 in the German Patent and Trademark Office, the disclosures of which are incorporated herein by reference in their entirety.

### BACKGROUND

### Technical Field

The present invention relates to a housing for receiving battery cells and a method for producing such a housing for receiving battery cells, for example for forming a traction battery for a motor vehicle.

### Related Art

Multi-part battery housings are known, whereof the housing parts are welded to one another to provide a housing which is closed with respect to the environment. In particular, in the case of vehicle battery housings for forming traction battery systems, it is known to assemble these housing from individual housing parts made of metal.

In this case, a pressure-tight sealing of the housing against gas and fluid exchange between the interior of the housing and the environment is important for providing operationally reliable and continuous functioning of the battery system and for protecting the battery cells received in the housing.

In this case, aluminum or aluminum alloys are a particularly suitable material since the resultant housing has a relatively low weight, aqueous corrosion rarely occurs and aluminum is not electrically conductive.

However, when using aluminum or aluminum alloys, sealing the housing parts against one another solely by welding is difficult. Instead, in the case of welded battery housings, some degree of leakiness of the housing is to be expected, for instance due to porous regions and/or blowholes in the weld joint.

Ensuring pressure-tight welded battery housings can therefore only be achieved with substantial reworking, which, amongst other things, includes a pressure check along with the localization of leak points and possibly re-welding. In some circumstances, the above-mentioned steps have to be carried out multiple times until the housing is sufficiently leak-tight. This is time-consuming and costly.

### SUMMARY

The present disclosure describes an improved housing for receiving battery cells, in particular a housing for receiving battery cells for producing a vehicle battery system, and a corresponding production method.

Accordingly, a housing for receiving battery cells, in particular for forming a vehicle battery system for a motor vehicle, is proposed, which includes a first housing part and a second housing part connected to the first housing part. A sealing channel is formed between the first housing part and the second housing part, wherein a sealant for sealing the first housing part with respect to the second housing part is arranged in the sealing channel.

As a result of a sealing channel being formed between the first housing part and the second housing part, wherein a sealant for sealing the first housing part with respect to the second housing part is arranged in the sealing channel, a multi-part housing whereof the interior is sealed with respect to the environment can be provided in a simple manner.

Complex test methods which are used to test the leak-tightness of the connection between the first and the second housing part and further rework steps for sealing the connection can therefore be reduced or even dispensed with completely.

According to some embodiments, the first housing part and the second housing part are welded and/or soldered and/or glued to one another, for example in spots and/or in sections and/or in lines. In other words, the first housing part is generally connected to the second housing part with material fit, wherein typically a plurality of weld spots, solder spots and/or glue spots and/or a continuous line joint are provided.

A reliable, durable and resilient connection between the first and the second housing part can thus be achieved, which generally has at least a partial sealing effect. The passage of gases, solids and/or liquids in the connecting region between the first and the second housing part is typically at least already impeded by the material-fitting connection.

The connection of the first housing part to the second housing part can thus also take place in an automated manner, for example by means of a robot.

If the first housing part and/or the second housing part is formed from metal, for example aluminum and/or an aluminum alloy, a particularly light and resistant housing with little tendency to age can be provided, which, at the same time, also has the structural properties required for safety reasons.

According to several embodiments, the first housing part and/or the second housing part is formed as an extruded profile. The individual housing parts can thus be produced and cut to different lengths in a simple manner so that different housing sizes can be realized in a simple manner.

To enable the sealant to be introduced into the sealing channel, according to a further embodiment, an inlet bore for introducing sealant into the sealing channel can be formed in the first housing part and/or the second housing part.

A ventilating bore for ventilating the sealing channel is generally also formed in the first housing part and/or the second housing part. It can thus be ensured that air located in the sealing channel, which is forced out of the sealing channel as the sealant is introduced, can escape from this. Moreover, the ventilating bore can also be used to check the sealant entry into the sealing channel, wherein at least one ventilating bore is typically provided at least at one end of the sealing channel. In this case, the checking of the sealant entry can take place visually or in an automated manner by means of a sensor which detects whether sealant is present in the ventilating bore or has emerged from this. Therefore, the ventilating bore can furthermore fulfill the function of an inspection opening for simple quality assurance.

The ventilating bore is generally arranged at an end of the sealing channel which is opposite the inlet bore in order to achieve full escape of the air from the sealing channel and full penetration of the sealing channel by the sealant.

The sealing channel can be provided in a particularly simple manner if, in a further embodiment, the sealing channel is formed accordingly by means of a recess or groove formed on the first housing part and/or on the second housing part.

By bringing the first and second housing part together, the outwardly open part of the recess in the one housing part is then closed by the other housing part so that a sealing channel with a substantially closed cross-section is formed. In other words, the sealing channel is formed by the interaction of the first and second housing part.

According to certain embodiments, the sealant includes a viscous sealant, wherein typically the sealant can be introduced into the sealing channel via the application of an application pressure and is present in the sealing channel such that it is positionally stable under ambient pressure.

In the present case, the term “viscous” refers to a thick, creamy, paste-like and/or semi-fluid property of the sealant. In other words, the viscous sealant is substantially dimensionally stable or positionally stable under ambient pressure so that, for instance, an uncontrolled flow of the sealant, at least on a slightly inclined surface, does not take place.

The sealant can generally be hardened so that, after hardening, it has a comparatively high viscosity value and/or has solid-state properties or is hardened to a solid state.

For example, the viscous sealant contains a solvent, which exits the sealant over time and so solidification of the sealant introduced into the sealing channel takes place. The sealant generally contains silicone and/or rubber and/or includes a silicone and/or rubber solvent, for example water-based.

According to several embodiments, the first housing part is connected to the second housing part by means of a form closure, for example by means of a tongue element, which is formed on the first or second housing part and engages in a groove element formed on the other housing part. A mechanically resilient connection can thus be produced in a simple manner.

According to various embodiments, the first housing part is connected to the second housing part by means of a form closure and by means of a material closure, for example by means of a tongue element, which is formed on the first or second housing part and engages in a groove element formed on the other housing part, and additionally by welding, soldering and/or gluing. In this case, the sealing channel is generally arranged between the material-fitting connection and the form-fitting connection. In other words, the form-fitting connection is located on one side of the sealing channel and the material-fitting connection is located on the other side of the sealing channel. The sealing channel and the sealant are thus protected with respect to mechanical environmental influences.

A method for producing a housing for receiving battery cells is described, including the steps of connecting a first housing part to a second housing part and introducing a sealant into a sealing channel formed between the first housing part and the second housing part after their connection.

As a result of the method, the effects and advantages described in relation to the housing and its embodiments are achieved analogously.

According to some embodiments of the method, the first housing part and/or the second housing part are produced by extrusion, for example aluminum extrusion, wherein, to form the sealing channel, wherein a recess or groove is generally provided in the first housing part and/or the second housing part.

According to several embodiments of the method, the first housing part and the second housing part are connected to one another with material fit, for example welded, soldered and/or glued.

According to some embodiments, the first and the second housing part are connected to one another with form fit, wherein generally a tongue element formed on the first or second housing part is inserted into a correspondingly formed groove element in the other housing part.

### BRIEF DESCRIPTION OF THE FIGURES

Further embodiments of the invention are explained in more detail by the following description of the figures.

FIG. 1 is a schematic perspective sectional view of a detail of a housing for receiving battery cells.

### DETAILED DESCRIPTION

Exemplary embodiments are described below with reference to the FIGURE.

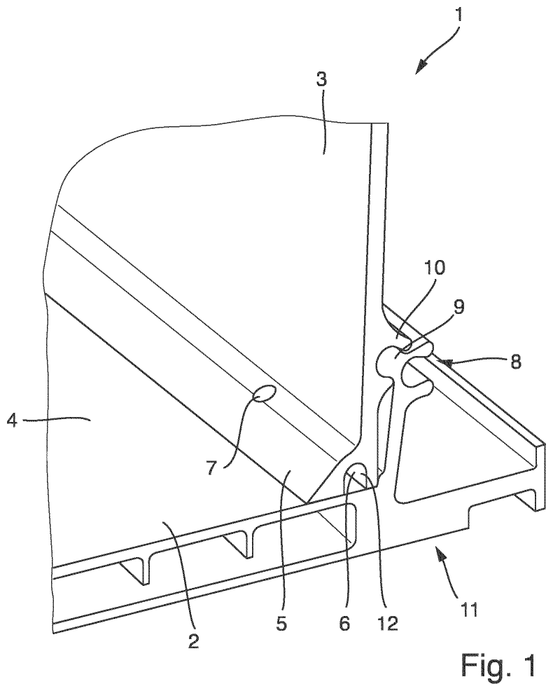

A perspective sectional view of a detail of a housing 1 for receiving battery cells is shown schematically in FIG. 1. The housing 1 can form the outer casing of a battery system of a traction battery for a motor vehicle, for example.

A first housing part 2 of the housing 1, which is formed as a base, is connected with material fit to a second housing part 3 formed as a side wall by a weld joint 5. In the exemplary embodiment shown, the weld joint 5 is formed as a line.

In other embodiments, however, the weld joint 5 can be formed in spots or in sections.

With respect to an interior 4 ultimately formed by the housing 1, a form closure 8 is additionally provided on the outside as seen from the weld joint 5, by means of which form closure the first housing part 2 and the second housing part 3 are additionally connected. In this case, an elongated tongue element 9 formed on the first housing part 2 is inserted into a groove element 10 formed on the second housing part 3.

Creating the form closure 8 between the first housing part 2 and the second housing part 3 can be important for the production of the housing 1, since the position of the housing parts 2, 3 with respect to one another can firstly be defined by the form closure 8 before the weld joint 5 is formed.

Creating the form closure 8 can also be important for the structural integrity of the housing 1 and can reduce the mechanical load acting on the weld joint 5 accordingly.

However, in a further embodiment of the housing 1, which is not shown here, the creation of the form closure 8 can be omitted and the individual housing parts 2, 3 can be connected to one another merely with material fit via the weld joint 5.

In the exemplary embodiment shown in FIG. 1, a sealing channel 6 is formed between the first housing part 2 and the second housing part 3, in which sealing channel a sealant for sealing a connecting region 11 formed between the first housing part 2 and the second housing part 3 is arranged.

The sealing channel 6 is provided by an outwardly open recess 12 formed in the second housing part 3. The outwardly open section of the recess 12 with respect to the second housing part 3 is closed by the first housing part 2 as a result of the assembly therewith, so that the sealing channel 6 has a substantially closed cross-section.

In the exemplary embodiment shown in FIG. 1, the sealing channel 6 is also formed between the form closure 8 and the weld joint 5.

Sealing of the first housing part 2 with respect to the second housing part 3 can be achieved by the sealant received in the sealing channel 6, so that the requirements relating to the leak-tightness of the weld joint 5 can be reduced or the weld joint 5, as already described above, can also be simply provided in the form of spot welds or section welds. This results in simplified production of the housing 1.

In the exemplary embodiment shown, the first housing part 2 and the second housing part 3 are each formed as aluminum extruded profiles. After these have been extruded and cut to a predetermined length, the form closure 8 is achieved by inserting the tongue element 9 into the groove element 10. The first housing part 2 and the second housing part 3 are thus securely positioned or at least pre-positioned relative to one another so that the weld joint 5 can then be added in a simple manner.

To introduce the sealant into the sealing channel 6, an inlet bore 7 is formed in the sealing channel 6 in the second housing part 3.

The sealant can include a viscous sealant, wherein the sealant can then be introduced into the sealing channel 6 via the application of an application pressure. After the application pressure is removed, the sealant is present in the sealing channel 5 such that it is positionally stable under ambient pressure. Therefore, reliable sealing of the first housing part 2 with respect to the second housing part 3 can be achieved.

At the ends of the sealing channel 6, ventilating bores (not shown in FIG. 1) are provided in the first or second housing part, through which air which is forced out of the sealing channel 6 as the sealant is introduced therein can escape. In addition, visual checking can take place through the ventilating bores to determine whether the sealing channel 6 has been filled completely with sealant. This is assumed to be the case if the sealant can be seen in the ventilating bore or is emerging from this.

The viscous sealant can include a silicone material whereof the solvent exits the sealant after a predetermined hardening period so that, after the hardening period, the sealant is present in a substantially hardened, and dimensionally and positionally stable state.

If applicable, all individual features which are presented in the exemplary embodiments can be combined and/or exchanged with one another without deviating from the scope of the invention.

1-13. (canceled)

14. A housing for receiving battery cells comprising:
a first housing part;
a second housing part connected to the first housing part; and
a sealing channel formed between the first housing part and the second housing part, wherein a sealant configured to seal the first housing part against the second housing part is disposed in the sealing channel.

15. The housing of claim 14, wherein the first housing part and the second housing part are welded, soldered, and/or glued to one another.

16. The housing of claim 14, wherein the first housing part and/or the second housing part comprises a metal.

17. The housing of claim 16, wherein the metal comprises aluminum and/or an aluminum alloy.

18. The housing of claim 14, wherein the first housing part and/or the second housing part are formed as an extruded profile.

19. The housing of claim 14, further comprising an inlet bore configured to admit the sealant into the sealing channel, wherein the inlet bore is formed in the first housing part and/or the second housing part.

20. The housing of claim 14, further comprising a ventilating bore configured to ventilate the sealing channel, wherein the ventilating bore is formed in the first housing part and/or the second housing part.

21. The housing of claim 20, wherein the ventilating bore is formed at one end of the sealing channel.

22. The housing of claim 14, wherein the sealing channel is formed by a recess formed at the first housing part and/or the second housing part.

23. The housing of claim 14, wherein the sealant comprises silicone and/or rubber, and/or includes a silicone solvent and/or a rubber solvent.

24. The housing of claim 14, further comprising a form closure configured to connect the first housing part to the second housing part.

25. The housing of claim 24, wherein the form closure comprises a tongue element formed on the first housing part or the second housing part, the tongue element configured to engage in a groove element formed on the other housing part.

26. A method for sealing a housing for receiving battery cells comprising:
connecting a first housing part to a second housing part; and
introducing a sealant into a sealing channel formed between the first housing part and the second housing part after their connection.

27. The method of claim 26, further comprising producing the first housing part and/or the second housing part by extrusion.

28. The method of claim 26, further comprising forming the sealing channel by providing a recess or a groove in the first housing part and/or the second housing part.

29. The method of claim 26, wherein connecting the first housing part to the second housing part comprises welding, soldering, and/or gluing the first housing part to the second housing part.

30. The method of claim 26, further comprising forming an inlet bore configured to introduce the sealant into the sealing channel, wherein the inlet bore is formed in the first housing part and/or the second housing part.

31. The method of claim 26, further comprising forming a ventilating bore configured to ventilate the sealing channel, wherein the ventilating bore is formed in the first housing part and/or the second housing part.

32. The method of claim 26, further comprising creating a form closure between the first housing part and the second housing part.

33. The method of claim 32, wherein creating the form closure comprises forming a tongue element on the first housing part or the second housing part, the tongue element configured to be inserted into a corresponding formed groove element in the other housing part.
